(19) United States
(12) Patent Application Publication
(10) Pub. No.: US 2008/0239077 A1
(43) Pub. Date: Oct. 2, 2008

(54) Motor vehicle accident recording system

(76) Inventor: John K. Kurylo, Ringoes, NJ (US)

Correspondence Address: Kenneth P. Glynn, 24 Mine Street, Flemington, NJ, 08822, US

(21) Appl. No.: 11/731,077

(22) Filed: Mar. 31, 2007

(51) Int. Cl. H04N 7/18

(52) U.S. Cl. 348/148; 348/E07.087

(57) ABSTRACT

A motor vehicle accident recording system for portable installation in a conventional motor vehicle includes: a.) a looping video camera to record audio and video through a windshield of a motor vehicle for a period of a predetermined time, and to record over previous recordings in excess of the predetermined time, start, stop, and recording retrieval capabilities; b.) an attachment mechanism connected to the video camera for attachment to a dashboard, a rear view mirror, a visor, a windshield and a windshield frame; c.) a control module that includes functional connection to the video camera to operate the start and the stop, that may be connected wirelessly or by wire. The module includes power hook up or power source and has an engine operation sensing device and, optionally, an impact sensing means, the engine operation sensing means recognizing when an engine of a motor vehicle is running and when it is not running and the impact sensing means senses severe impact from sudden rapid deceleration or sudden stop; the control module having a microchip that will initiate the video camera start means when a motor vehicle engine is turned on and will initiate the video camera stop means on a delayed basis upon the first stop action to occur of: the motor vehicle engine stops or impact is sensed, such that the video camera will be stopped at some predetermined time after the stop action occurs

### BACKGROUND OF INVENTION

a. Field of Invention

The invention relates generally to an automated system for recording motor vehicle accidents that is installed in a motor vehicle and includes a sensing device that continuously operates a camera when the engine is running. It stops after a predetermined time has passed after the engine is stopped, e.g., after 60 seconds pass after the engine stops. Thus, it will record and store the scene before and at the time of an accident, as well as seconds after an accident. It not only will aid in creating a record of an accident for causation determination, but may even record when a party wrongfully moves a vehicle before police arrive or make an admission.

b. Description of Related Art

The following patents are representative of recording systems of trigger events or overwrite of data storage:

U.S. Pat. No. 7,088,387 to Freeman, et al. describes a compact video image recording device for recording video images before and after a triggering event and which utilizes no moving parts is disclosed. The recording device includes at least one camera wherein each camera comprises a lens and a video image sensor. Each video image sensor generates an electronic signal representative of a video image impinging the respective sensor. The output of each image sensor is processed, compressed and generally employed to produce frame data which are successively stored in successive frame locations of a semiconductor memory organized as a circular buffer memory. Upon the occurrence of a triggering event, additional frames are stored in the buffer memory and further storage of frames then terminates. A video record is thus created of video images received both before and after the triggering event via a device which contains no moving parts and which can withstand substantial shock and vibration.

U.S. Pat. No. 7,012,632 to Freeman, et al. describes a method which stores a plurality of sequentially ordered data samples in a plurality of sequential storage segments such that one of the plurality of sequentially ordered data samples is stored at one of the plurality of sequential storage segments which is non-sequential to another of the plurality of sequential storage segments in which an immediately preceding one of the plurality of sequentially ordered data samples is stored. Another one of the stored plurality of sequentially ordered data samples, other than a first ordered one of the plurality of sequentially ordered data samples, is overwritten with a further data sample, the further data sample being immediately sequential to a last ordered one of the plurality of sequentially ordered data samples.

U.S. Pat. No. 4,281,354 to Conte describes an invention which consists of an apparatus for recording accidental events relating to movable devices such as automotive vehicles, which events can be sensed by optical observation, and comprises: detecting means for receiving the images of the event and transforming them into electric signals; a signal storing circuit comprising one or more analog memories, wherein the recording of successive events is carried out by automatically erasing the oldest image; and sensor means for assuring automatic interruption of the incoming signal flow from the image detecting means to the memories to achieve the automatic nonerasable storage of images corresponding to a predetermined period immediately preceding and contemporary to the accidental event.

Notwithstanding the prior art, the present invention is neither taught nor rendered obvious thereby.

### SUMMARY OF INVENTION

The present invention is a motor vehicle accident recording system for portable installation in a conventional motor vehicle, such as an automobile, truck, SUV or the like. The device is different from prior art devices because it relies upon unique sensors for starting and ending a continuous loop video camera recording. (The term “continuous loop” and “looping” were originally in reference to a moving video tape that was an endless loop that was taped over and over as in the pioneer days of surveillance cameras with video tapes. In this application, these terms refer to the electronic, digital equivalent of rolling tape, i.e. storing data and then automatically supplanting it with newer data.) The present invention recording system includes: a.) a looping video camera including means to record audio and video through a windshield of a motor vehicle for a period of a predetermined time, and to record over previous recordings in excess of the predetermined time, start means, stop means, and recording retrieval means; b.) attachment means connected to the video camera for attachment thereto at least one motor vehicle component selected from the group consisting of a dashboard, a rear view mirror, a visor, a windshield and a windshield frame; and c.) a control module that includes connection means to functionally connect to the video camera to at least operate the start means and the stop means, the connection means being selected from the group consisting of wireless connection and wire connection, the module including power means and including engine operation sensing means, the engine operation sensing means recognizing when an engine of a motor vehicle is running and when it is not running; the control module having a microchip that will initiate the video camera start means when a motor vehicle engine is turned on and will initiate the video camera stop means on a delayed basis when the motor vehicle engine is turned off, such that the video camera will be stopped at some predetermined time after the motor vehicle engine is stopped. The engine sensing means operating sensing means may be under the hood, on the dash, connected to the battery or otherwise connected to a vehicle feature that will recognize engine sound, engine vibration, engine heat or engine current or voltage changes to recognize when an engine is running and when it is not. If the device is remotely located from the rest of the control module, it may be functionally connected thereto by wire or wirelessly.

In some preferred embodiments of the present invention motor vehicle accident recording system, the engine operation sensing means includes direct connection to an engine operating connection of the motor vehicle, such as an ignition key, a shift lever, a carburetor lever, a transmission component or the like.

In some preferred embodiments of the present invention motor vehicle accident recording system, the engine operation sensing means includes connection to an electrical component that would indicate engine operation. Thus, in some preferred embodiments of the present invention motor vehicle accident recording system, the engine operation sensing means is a current sensing means or is a voltage sensing means and recognizes when an engine is recharging the battery through the generator or similar device.

In some preferred embodiments of the present invention motor vehicle accident recording system, the video camera is a digital camera, although it could be non-digital and still within the scope of the present invention.

In some preferred embodiments of the present invention motor vehicle accident recording system, the looping video camera includes a serial port for downloading stored information to a computer.

In some preferred embodiments of the present invention motor vehicle accident recording system, the control module is contained within a housing separate from the video camera, while in others it is separate and remotely located therefrom.

In some preferred embodiments of the present invention motor vehicle accident recording system, the video camera includes a video screen.

In some preferred embodiments of the present invention motor vehicle accident recording system, the control module microchip is a programmable microchip that includes programmable means to set a specific predetermined amount of time for the delay of initiating the stop means of the video camera.

While the present invention device has been described above as on relying upon an engine operating sensing means, in other embodiments, the present invention may rely in combination on both engine running sensors and impact sensors so that the camera will have a delayed shut down even if there is an accident and the engine keeps running. In these cases, the accident wherein the engine keeps running will not cause the camera to keep rolling to the point where the accident recording is lost due to a recording over it. The impact sensor will sense the impact of the accident and will “kill the recording” within the prescribed preset time After the accident, even if the engine operating sensor sees the engine still running. Thus, in some preferred embodiments of the present invention motor vehicle accident recording system, the invention includes: a.) a looping video camera including means to record audio and video through a windshield of a motor vehicle for a period of a predetermined time, and to record over previous recordings in excess of the predetermined time, start means, stop means, and recording retrieval means; b.) means connected to the video camera for attachment thereto at least one motor vehicle component selected from the group consisting of a dashboard, a rear view mirror, a visor, a windshield and a windshield frame; c.) a control module that includes connection means to functionally connect to the video camera to at least operate the start means and the stop means, the connection means being selected from the group consisting of wireless connection and wire connection, the module including power means and including engine operation sensing means and impact sensing means, the engine operation sensing means recognizing when an engine of a motor vehicle is running and when it is not running and the impact sensing means senses severe impact from sudden rapid deceleration or sudden stop; the control module having a microchip that will initiate the video camera start means when a motor vehicle engine is turned on and will initiate the video camera stop means on a delayed basis upon the first stop action to occur of: the motor vehicle engine stops or impact is sensed, such that the video camera will be stopped at some predetermined time after the stop action occurs. All of the features set forth in the previous paragraphs of this Summary section may also be incorporated with these embodiments, alone or in various combinations.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a block diagram showing the important features of one embodiment of the present invention motor vehicle accident recording system for portable installation in -a conventional motor vehicle;

FIG. 2 illustrates in block form different camera options for the present invention motor vehicle accident recording system; and,

FIG. 3 is a is a block diagram showing the important features of another embodiment of the present invention motor vehicle accident recording system for portable installation in a conventional motor vehicle.

### DETAILED DESCRIPTION OF THE EMBODIMENTS

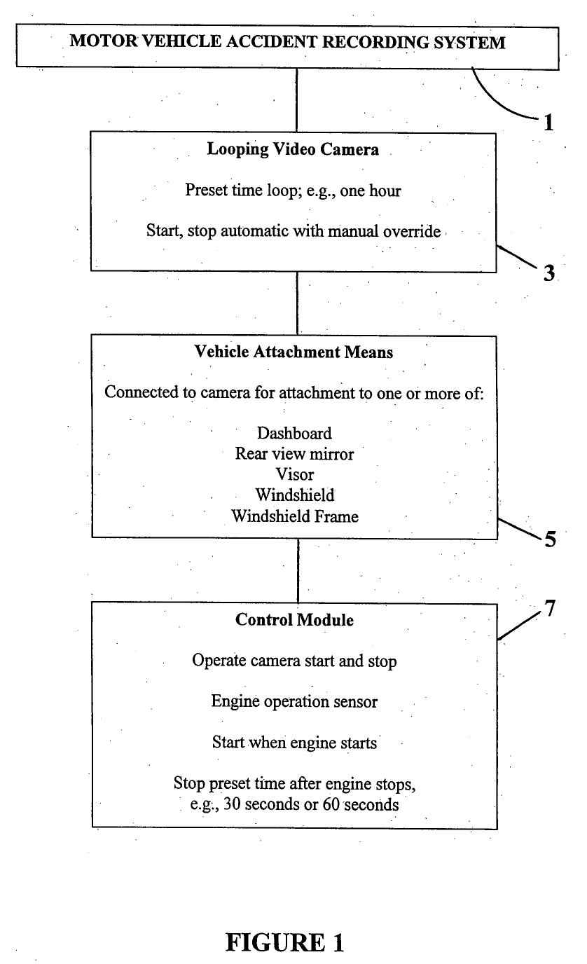

FIG. 1 is a block diagram showing the important features of one embodiment of the present invention motor vehicle accident recording system 1 for portable installation in a conventional motor vehicle. Looping video camera 3 is preferably a digital video camera with a built in, wired or plug in power source, e.g. battery operated, automobile-wired, cigarette lighter plug in, wired male/female plug-in, etc. It has a preset time loop for filming, e.g. one hour, three hours or otherwise, and has a start means and a stop means that are automatic with manual override. Vehicle attachment means 5 is connected to the camera for attachment to one or more of a dashboard, rear view mirror, visor, windshield, windshield frame, handle bars of a motorcycle or other vehicle front end component. It may be welded, glued, screwed, riveted or otherwise connected to the camera and may itself have connection means for attachment to one or more of the foregoing front end components, such as Velcro hook and loop strips, brackets that may be screwed, glued or clamped, etc. Radar detector attachments are well known and these types could be used for the camera in the current invention. Control Module 7 operates the camera start and stop mechanisms with an engine operation sensor so as to start the camera when the engine starts, and so as to stop the camera a preset time after engine stops e.g. 30 seconds or 60 seconds. The engine operation sensor may be any of those described in the Summary section above.

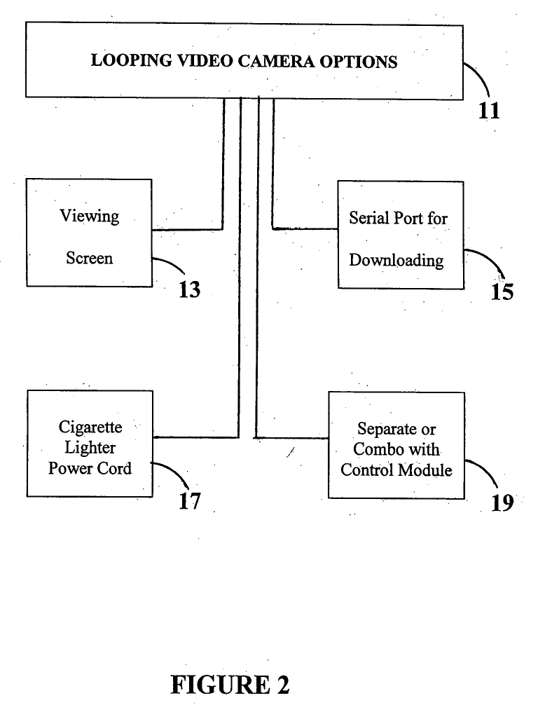

FIG. 2 illustrates in block form the different camera options 11, for the present invention motor vehicle accident recording system. These include a viewing screen 13, a serial port 15 for downloading data to a computer or equivalent device, a cigarette lighter power cord 17. The camera may be within the same housing or separate or housing from the control module 19.

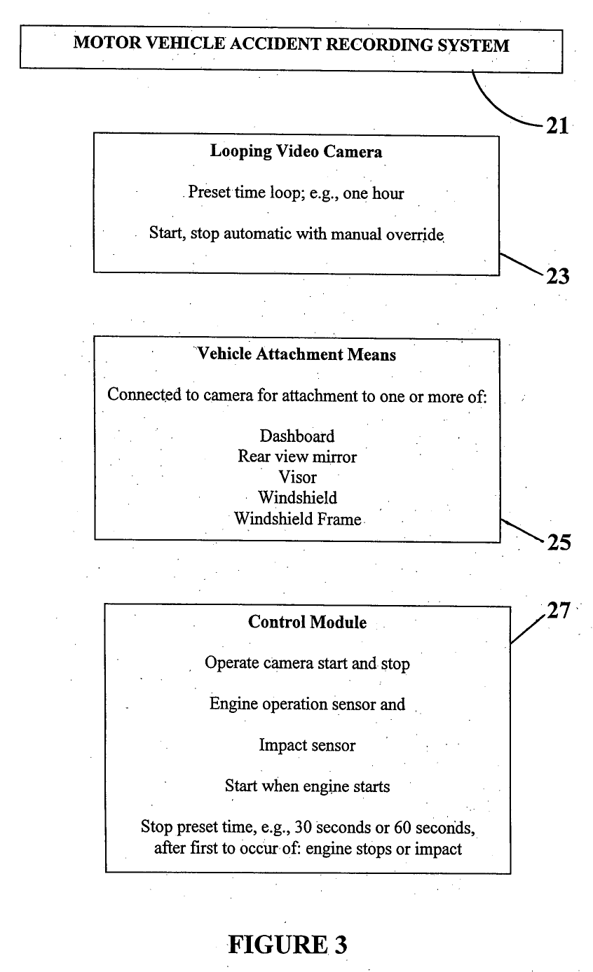

FIG. 3 is a is a block diagram showing the important features of another embodiment of the present invention motor vehicle accident recording system 21 for portable installation in a conventional motor vehicle. Looping video camera 23 is preferably a digital video camera with a built in, wired or plug in power source, e.g. battery operated, automobile-wired, cigarette lighter plug in, wired male/female plug-in, etc. It has a preset time loop for filming, e.g. one hour, three hours or otherwise, and has a start means and a stop means that are automatic with manual override. Vehicle attachment means 25 is, connected to the camera for attachment to one or more of a dashboard, rear view mirror, visor, windshield, windshield frame, handle bars of a motorcycle or other vehicle front end component. It may be welded, glued, screwed, riveted or otherwise connected to the camera and may itself have connection means for attachment to one or more of the foregoing front end components, such as Velcro hook and loop strips, brackets that may be screwed, glued or clamped, etc. Radar detector attachments are well known and these types could be used for the camera in the current invention. Control Module 27 operates the camera start and stop mechanisms with a combination of an engine operation sensor and an impact sensor so as to start the camera when the engine starts, and so as to stop the camera a preset time after a stop action event occurs, e.g. 30 seconds or 60 seconds after first to occur of the engine stops or there is a severe impact. The engine operation sensor may be any of those described in the Summary section above.

The present invention systems enable drivers to easily install and remove a video camera for recording events such as accidents and the control module itself may be permanently or temporarily installed in the vehicle as well.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A motor vehicle accident recording system for portable installation in a conventional motor vehicle, which comprises:
a.) a looping video camera including means to record audio and video through a windshield of a motor vehicle for a period of a predetermined time, and to record over previous recordings in excess of said predetermined time, start means, stop means, and recording retrieval means;
b.) means connected to said video camera for attachment thereto at least one motor vehicle component selected from the group consisting of a dashboard, a rear view mirror, a visor, a windshield and a windshield frame;
c.) a control module that includes connection means to functionally connect to said video camera to at least operate said start means and said stop means, said connection meansibeing selected from the group consisting of wireless connection and wire connection, said module including power means and including engine operation sensing means, said engine operation sensing means recognizing when an engine of a motor vehicle is running and when it is not running; said control module having a microchip that will initiate said video camera start means when a motor vehicle engine is turned on and will initiate said video camera stop means on a delayed basis when said motor vehicle engine is turned off, such that said video camera will be stopped at some predetermined time after said motor vehicle engine is stopped.

2. The motor vehicle accident recording system of claim 1, wherein said engine operation sensing means includes direct connection to an engine operation connection of said motor vehicle.

3. The motor vehicle accident recording system of claim 1, wherein said engine operation sensing means includes connection to an electrical component that would indicate engine operation.

4. The motor vehicle accident recording system of claim 1, wherein said engine operation sensing means is a current sensing means.

5. The motor vehicle accident recording system of claim 1, wherein said video camera is a digital camera.

6. The motor vehicle accident recording system of claim 1, wherein said looping video camera includes a serial port for downloading stored information to a computer.

7. The motor vehicle accident recording system claim 1, wherein said control module is contained within a housing separate from said video camera.

8. The motor vehicle accident recording system claim 1, wherein said video camera includes a video screen.

9. The motor vehicle accident recording system of claim 1, wherein said control module microchip is a programmable microchip that includes programmable means to set a specific predetermined amount of time for said delay of initiating said stop means of said video camera.

10. The motor vehicle accident recording system of claim 9, wherein said engine operation sensing means includes direct connection to an engine operation connection of said motor vehicle.

11. The motor vehicle accident recording system of claim 9, wherein said engine operation sensing means includes connection to an electrical component that would indicate engine operation.

12. The motor vehicle accident recording system of claim 9, wherein said video camera is a digital camera.

13. The motor vehicle accident recording system of claim 9, wherein said control module microchip is a programmable microchip that includes programmable means to set a specific predetermined amount of time for said delay of initiating said stop means of said video camera.

14. A motor vehicle accident recording system for portable installation in a conventional motor vehicle, which comprises:
a.) a looping video camera including means to record audio and video through a windshield of a motor vehicle for a period of a predetermined time, and to record over previous recordings in excess of said predetermined time, start means, stop means, and recording retrieval means;
b.) means connected to said video camera for attachment thereto at least one motor vehicle component selected from the group consisting of a dashboard, a rear view mirror, a visor, a windshield and a windshield frame;
c.) a control module that includes connection means to functionally connect to said video camera to at least operate said start means and said stop means, said connection means being selected from the group consisting of wireless connection and wire connection, said module including power means and including engine operation sensing means and impact sensing means, said engine operation sensing means recognizing when an engine of a motor vehicle is running and when it is not running and said impact sensing means senses severe impact from sudden rapid deceleration or sudden stop; said control module having a microchip that will initiate said video camera start means when a motor vehicle engine is turned on and will initiate said video camera stop means on a delayed basis upon the first stop action to occur of: said motor vehicle engine stops or impact is sensed, such that said video camera will be stopped at some predetermined time after said stop action occurs.

15. The motor vehicle accident:recording system of claim 14 wherein said engine operation sensing means includes direct connection to an engine operation connection of said motor vehicle.

16. The motor vehicle accident recording system of claim 14 wherein said engine operation sensing means includes connection to an electrical component that would indicate engine operation.

17. The motor vehicle accident recording system of claim 14 wherein said video camera includes at least one feature selected from the group consisting of: (a.) cigarette lighter-connectable power cord; (b.) video screen; and (c.) serial port for downloading stored information to a computer.

18. The motor vehicle accident recording system of claim 14 wherein said video camera is a digital camera.

19. The motor vehicle accident recording system of claim 14 wherein said control module microchip is a programmable microchip that includes programmable means to set a specific predetermined amount of time for said delay of initiating said stop means of said video camera.

20. The motor vehicle accident recording system of claim 14 wherein said control module is contained within a housing separate from said video camera.
